(19) United States
(12) Patent Application Publication
(10) Pub. No.: US 2026/0094033 A1
(43) Pub. Date: Apr. 2, 2026

(54) DYNAMIC EXPLAINABLE ARTIFICIAL INTELLIGENCE PIPELINE COMPOSABILITY AND CUSTOMIZATION

(71) Applicant: Intel Corporation, Santa Clara, CA (US)

(72) Inventors: Ria Cheruvu, Tempe, AZ (US); Harsha Bajpai, Kanpur, Uttar Pradesh (IN); Arshad Mehmood, BANDAR CASSIA (MY); Saima Sharmin, Santa Clara, CA (US)

(21) Appl. No.: 19/111,676

(22) PCT Filed: Mar. 30, 2023
(86) PCT No.: PCT/US2023/016946

§ 371 Date: Mar. 13, 2025

Related U.S. Application Data
(60) Provisional application No. 63/406,983, filed on Sep. 15, 2022.

(51) Int. Cl. G06N 5/045

(52) U.S. Cl. CPC G06N 5/045

(57) ABSTRACT

Various systems and methods are described for explainable artificial intelligence (AI) operations, workflows, and implementing systems are discussed. In an example, explainable AI operations are coordinated in a computing system, by: receiving a schema for the explainable AI operations, the schema corresponding to a persona role used to evaluate an AI model; coordinating or performing the explainable AI operations, the explainable AI operations including: data analysis on output data produced from the AI model, and model analysis on performance of the AI model; and outputting explanation data from the explainable AI operations, the explanation data customized based on the schema. The explanation data may include a variety of data metrics and values used for reports, deployment, and monitoring.

### PRIORITY CLAIM

This application claims the benefit of priority to U.S. Provisional Ser. No. 63/406,983 , filed Sep. 15, 2022, and titled “DYNAMIC EXPLAINABLE ARTIFICIAL INTELLIGENCE (AI) PIPELINE COMPOSABILITY AND CUSTOMIZATION FOR AI STAKEHOLDER PERSONAS”, which is incorporated herein by reference in its entirety.

### BACKGROUND

Explainable Artificial Intelligence (“XAI”, or “Explainable AI”) methods can be used to debug and analyze the use of AI models. However, existing approaches to implement XAI methods do not scale well in many types of real-world computing deployments, such as those provided by “edge computing”and related “edge”, “edge-cloud”, and “near-cloud”environments.

Edge computing, at a general level, refers to the transition of compute and storage resources closer to endpoint devices (e.g., consumer computing devices, user equipment, etc.), in order to optimize total cost of ownership, reduce application latency, improve service capabilities, and improve compliance with compute security or data privacy requirements. Edge computing may, in some scenarios, provide a cloud-like distributed service that offers orchestration and management for applications among many types of storage and compute resources.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 depicts sample phases of an AI workflow, according to an example.

FIG. 2 illustrates a sample use case illustrating scalable explainable AI reporting workflows in a computer vision problem, according to an example.

FIG. 3 depicts a structure of an explainable AI system, according to an example.

FIGS. 4A to 4C depict architecture diagrams for AI data processing, according to an example.

FIGS. 5A and 5B depict AI pipeline data flows, according to an example.

FIGS. 6A to 6C depict workflows for explainable AI use cases, according to an example.

FIG. 7 depicts a diagram providing for use of a size sensitivity mechanism, according to an example.

FIG. 8 depicts sample data from a size sensitivity mechanism, according to an example.

FIG. 9 depicts a diagram providing for use of a cohort analysis mechanism, according to an example.

FIG. 10 depicts sample data from a cohort analysis mechanism, according to an example.

FIGS. 11A to 11D depict cohort analysis and reliability scoring workflows, according to an example.

FIG. 12 depicts a diagram providing for use of a confusion matrix analysis, according to an example.

FIG. 13 depicts results of natural language explanation interpretation of size sensitivity results, according to an example.

FIG. 14 depicts a flowchart of an example method for implementing explainable AI data operations, according to an example.

FIG. 15 illustrates an overview of an edge cloud configuration for edge computing, according to an example.

FIG. 16 illustrates a block diagram of example components in a computing device that can operate as a compute processing platform, according to an example.

### DETAILED DESCRIPTION

In the following description, methods, configurations, and related apparatuses are disclosed for implementations of Explainable AI (XAI) technologies. These technologies may be implemented as part of a framework for automated AI model manifests, and integrated into various software development, debug, testing, or application use platforms. The following introduction elaborates on three use cases for XAI, and improved approaches for addressing these use cases. Other use cases will also be apparent.

Use Case 1: Ethical AI checks. One aspect of responsible and explainable AI is evaluating the ethical impact of AI systems, which may impact the brand reputation of stakeholders involved in AI model and service providing, consumption, servicing, etc. One of the industry efforts used for XAI reporting is known as a “model card”, which is a short data report detailing the ethical considerations, limitations, and quantitative breakdown (e.g., ethical checks) of a particular AI model. Different types of model cards are being developed for open-source AI models and for AI models from industry companies. The metrics covered in these reports expand beyond typical performance measures. XAI reporting, for example, may include: (1) Data explanations and quality metrics (as an example, the lighting conditions and levels of occlusion in training image dataset samples); (2) Robustness analyses, to identify how the model behaves in different and difficult environments; and (3) Telemetry data. One objective of XAI reporting is to pull out and visualize key elements of the AI pipeline that are relevant from an ethical and explainable perspective. Further, an objective of data explanations and checks is to identify if the data over-represents certain cohorts—such as if there is a larger number of data samples containing large objects, compared to objects of a smaller-medium size. Accordingly, data quality is an imperative since these types of elements can introduce bias and performance deficiencies into the model if not identified and controlled. Additional connections between XAI for data and AI quality are addressed below in relation to risk management.

Use Case 2: Validation checks of failure modes for AI algorithms. AI systems can fail in many ways (e.g., a sudden performance drop on only one data slice), due to multiple causes. Identifying these deficiencies and communicating them to the relevant stakeholders are important tasks to improve consumer confidence in AI pipelines. Further, validation may help to identify critical issues ahead of time that may have a high detrimental risk to the AI use case, potentially leading to financial liabilities, damaged brand reputation, etc.

Use Case 3: Reporting for risk management use cases. Quality assurance (QA) for data and AI has been highlighted as a defining industry trend. AI techniques also are part of new area of compliance mandated by standards bodies, presenting many technical challenges. Data quality has been identified as a key industry trend and market, with its own set of critical capabilities. AI is positioned as both a driver and a consumer of this data making up the set of tools and strategies targeted at augmented data quality. Upcoming regulatory action, such as National Institute of Standards and Technology's Risk Management Framework and the ISO IEC JTC1 SC42 initiatives, are defining new requirements and architectural elements for AI quality. For instance, ISO IEC SC42 has identified AI quality as a challenge—providing an initiative in “Artificial intelligence—Quality evaluation guidelines for AI systems”, that suggests mandates for measurements and compliance with the AI quality attributes, such as maintainability, security, functional correctness, etc.

XAI may be involved with many aspects of the transparency and reporting of AI quality metrics. For example, the outputs from XAI methods may be added into risk management records to ensure traceability, accountability, and monitoring of AI systems in compliance with regulations. However, the use of XAI methods leads to multiple technical issues in AI pipelines. The relevant considerations for these technical issues are addressed by one or more of the following aspects.

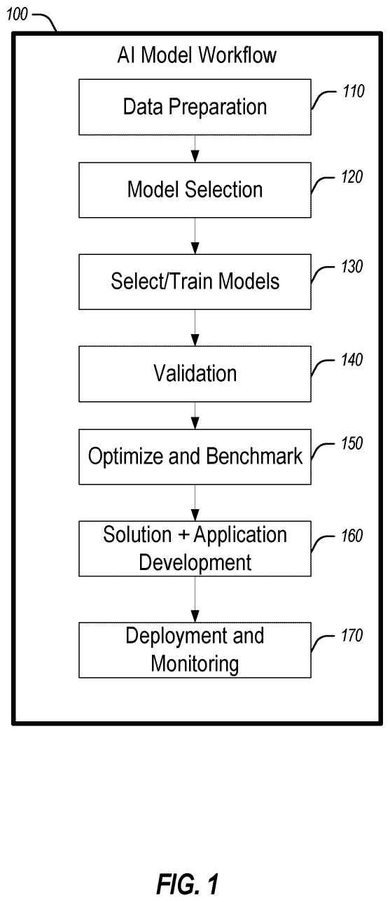

FIG. 1 presents sample phases of an AI workflow 100 to provide context for the approaches discussed herein. The phases (e.g., stages) of the AI workflow 100 include as an example: Data Preparation 110; AI Model Selection 120; Selection and Training 130 of the AI model(s); Validation 140 of the AI model(s); Optimization and Benchmarking 150 of the AI model(s); Solution and Application Development 160 to use the AI model(s); and Deployment and Monitoring 170 for the use of the AI model(s).

Each of these phases involves a set of metadata elements that may add or remove metadata in the existing elements including based on operations in previous stages. For example, metadata from the Data Preparation 110 stage addressing the representativeness properties of the data will carry over to the Optimization and Benchmarking 150 stage to then assess the model performance using the data representativeness metrics. Due to these types of dependencies, XAI and metadata assets differ depending on the lifecycle phase, use case, and type of AI model. The following provides additional detail on how stakeholder expectations may result in prioritizing certain types of metadata and the associated mechanisms (e.g., to generate certain types of metadata over others), and how to implement features of an XAI implementation.

In addition to the different types of metadata that can be generated depending on the lifecycle phase and model type of an AI workflow, the mechanisms used to generate metadata will also consequently differ. Numerous upcoming regulations, such as Singapore's Model Governance Framework, recommend a combination of explainable AI methods to be invoked for a number of use cases. In this sense, the AI asset to explain and the use case for the AI asset may be the same or similar, but methods applied towards explaining the asset with an XAI method and determining the exact outputs of the XAI method may differ.

Different types, sets, or families of XAI methods are compatible with certain data types and may offer tradeoffs accordingly. The examples discussed below refer to how XAI methods can be applied towards a computer vision problem statement, including a few elements of data and model analysis. Other types of data and problems besides computer vision image processing may be involved. In the case of the data analysis components, workflows can be customized to provide more granularity with specific types of representativeness analyses, building on the generic workflow depicted in FIG. 1. Other examples highlight the exact types of XAI methods-and the associated metadata that the XAI methods generate-that may contribute to the analysis. The particular arrangement of elements in this workflow to narrow down to specific reporting, including composable XAI element reporting, provides important benefits which are detailed below.

Stakeholders have different expectations corresponding to different components of AI model. An AI model developer may seek far more detailed, granular explanation techniques such as visualizing the inner feature activations of a deep learning (DL) model at a given point in time. In comparison, a business owner may wish to understand the model's high-level performance over time and understand the overall use cases where the model is failing and impacting their revenue, business operations, or other factors. To further add to the complexity of the problem, stakeholders'expectations are also expected to differ based on the lifecycle phase. Here, an AI developer will most likely require full access to an AI model's weights and explanations during the training process but will not require this access during the deployment phase when the model is handed over to the business owner. As another example, if a model risk evaluator is brought in to evaluate the AI model during deployment, then ideally the evaluator can use explainable AI methods to debug the model at a summary level without accessing sensitive end-user data, as permitted by the relevant stakeholders.

For the purposes of context, these and other types of stakeholders may be involved in AI and XAI methods. These may include: (i) Model Developers (e.g., ISVs) who are concerned with debugging and performance increases, biases; (ii) Business owners, who are concerned with the fit of the model and agreement of use for the AI use case, and transferability; (iii) Data controllers, who establish the purpose and methods of processing data, including the system setup and security of the system design; (iv) Data processors (e.g., a data controller or third party), who process the personal data, may be impacted by the restrictions and privacy aspects; (v) Model risk evaluators (e.g., Service Providers), who are concerned with robustness and deployment readiness; (vi) Regulators or a Supervisory Authority (e.g., Service Providers), who are concerned with a reliability and impact assessment, and auditing functionality; and (vii) Users/consumers, who are concerned with transparency and the ultimate effect of AI processing. Thus, as discussed herein, user roles from AI workflows may include: Domain Expert; Generalist Full Stack Developer; Data Engineer; Data Scientist/Deep Learning Specialist; Solutions/Services Architect; AI Software Developer; Application Developer; DevOps; Business owner; Model Validator; AI Ops Engineer.

In addition to the AI pipeline debug opportunities that XAI can enable, visual comprehensibility is a key part of ethical and explainable features of AI. Visual comprehensibility can assist, for example, when stakeholders are not advanced AI expert engineers or data scientists but are business users or end-users. Consequently, not all XAI metadata and asset explanations are necessary to expose to any type of stakeholder during runtime. A further consideration may include the scalability of technical mechanisms and reporting workflows that involve XAI.

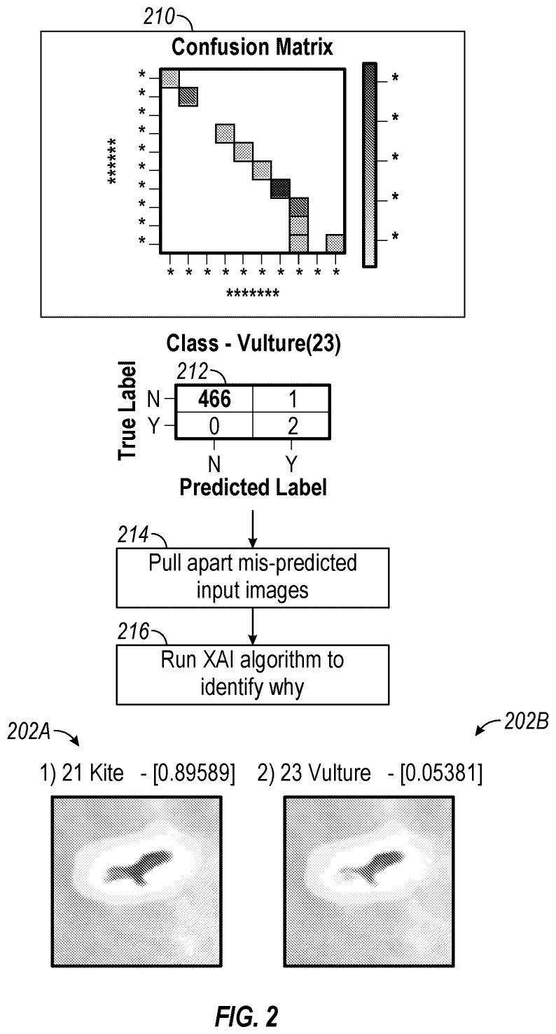

FIG. 2 illustrates a sample use case illustrating a use case for scalable XAI reporting workflows. This AI model use case depicts a computer vision problem with numerous data points and a classification label produced for an image from the AI model labels. However, as shown, an expected “vulture” classification 202B is not applied to the input image, but instead a “kite” classification 202A is erroneously applied to the input image. In this setting, the objective of the stakeholder is to identify the failure modes of the AI system. It may be technically infeasible to generate saliency maps for every single data point, both from a runtime perspective as well as from the perspective of a human stakeholder who would need to evaluate such efforts.

The technical challenges of evaluating AI failure modes can be addressed with the use of XAI reporting workflows as disclosed herein. The elements at the top of the pipeline depicted in FIG. 2 demonstrate the use of a multilabel confusion matrix 210 addressing multiple different class labels (e.g., classification labels such as the vulture class) to generate a high-level perspective of the AI model's failures. Then, a user can select the “vulture” class at 212 to narrow down and identify the number of false positives and negatives of the AI model. A saliency map can be leveraged at operation 214 to analyze mis-predicted input images, to help identify exactly why a specific false positive occurred with a small amount of data samples (e.g., 1-10 images). Finally, an XAI algorithm and workflow may be applied at operation 216 to identify why the failure occurred, and to provide suitable notifications to users and stakeholders.

The following approaches enable creation and use of a variety of composable XAI pipelines for similar types of analysis. There are important implications of these types of composable pipelines for orchestration of machine learning operations (MLOps). Efficient schedulers can be integrated based on the results of the MLOps.

Previous approaches that have focused on MLOps pipelines do not fully address many relevant considerations for XAI. These include technical considerations such as: a) Composability, where different XAI elements can be combined sequentially and orchestrated to generate unique reports; b) Customization, so that reports can be tailored to different stakeholder expectations/personas; and (c) Integration and connection of the MLOps pipelines to XAI workflows. In regard to b) Customization, a specific objective addressed by the following includes the ability to target individual personas. For example, the techniques described herein can help form sub-groups of AI developers'personas under a main “model developer” stakeholder group composed of individual persona with different motivations (e.g., unit testing, training, validation, data analysis).

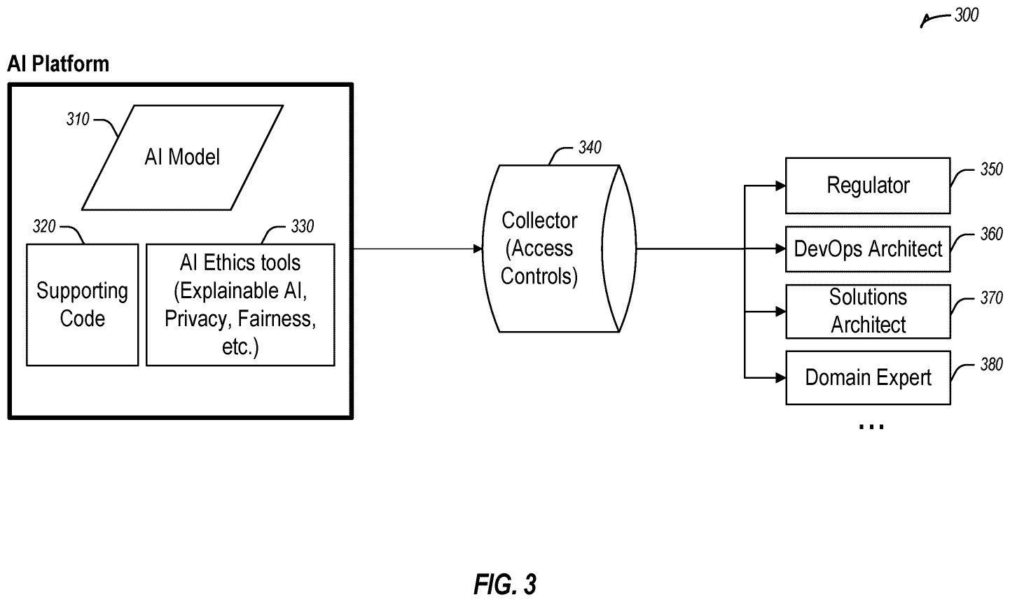

FIG. 3 depicts a structure of an explainable AI system 300, according to an example. Here, supporting code 320 and AI ethics tools 330 are operating within an AI platform in parallel to (or, attached to) an AI model 310. A controller (e.g., provided by a data collector 340) includes access controls to help designate what information is passed to which of the stakeholders. The explainable AI system 300 as shown provides a dynamic stakeholder segmentation of AI pipeline outputs to accommodate different user interests and capabilities for personas. Examples of such personas include a stakeholder such as Regulator 350, DevOps architect 360 (e.g., engineer), Solutions Architect 370, or a Domain Expert 380 (e.g., a data scientist). The controller can operate at the cloud or in edge computing settings (or in both).

The relevant technical features of this AI system 300 include an implementation of reconfigurable AI reporting workflows, specifically considering XAI elements in the context of key industry trends and requirements from upcoming regulations around transparency. Such XAI elements include: composability (to orchestrate composable XAI elements for scalability of reporting); arrangement (e.g., to arrange elements in this workflow to narrow down to specific reporting, such as in composable XAI element reporting); and customization (e.g., to control the level of explainability for an AI pipeline, tailored to stakeholder expectations, to help stakeholders truncate explainability interdependencies to best suit their purposes). These capabilities may be integrated into a development, testing, or debugging platform (e.g., a development platform such as Intel® DevCloud), where both console and user interface (UI) support can be enabled.

By establishing these capabilities, it is possible to implement more advanced features of XAI, such as to implement testable user personas within the framework with set of requirements to autonomously evaluate if an AI model is meeting some ethical criteria. Customers can efficiently adapt the proposed AI system 300 and designate stakeholders for individual use cases, extracting different outcomes for their stakeholder personas. This is particularly valuable in cases where multiple explainable AI operations are being used and form a series of interdependencies, where the system will be used to help stakeholders truncate and organize explainability operations to best suit their purposes.

The following examples provide a detailed discussion of an AI model providing computer vision classification and object detection applications. However, it will be understood that the proposed system is not limited to image processing but may also apply to Natural Language Processing and a variety of other AI domains including generative AI applications.

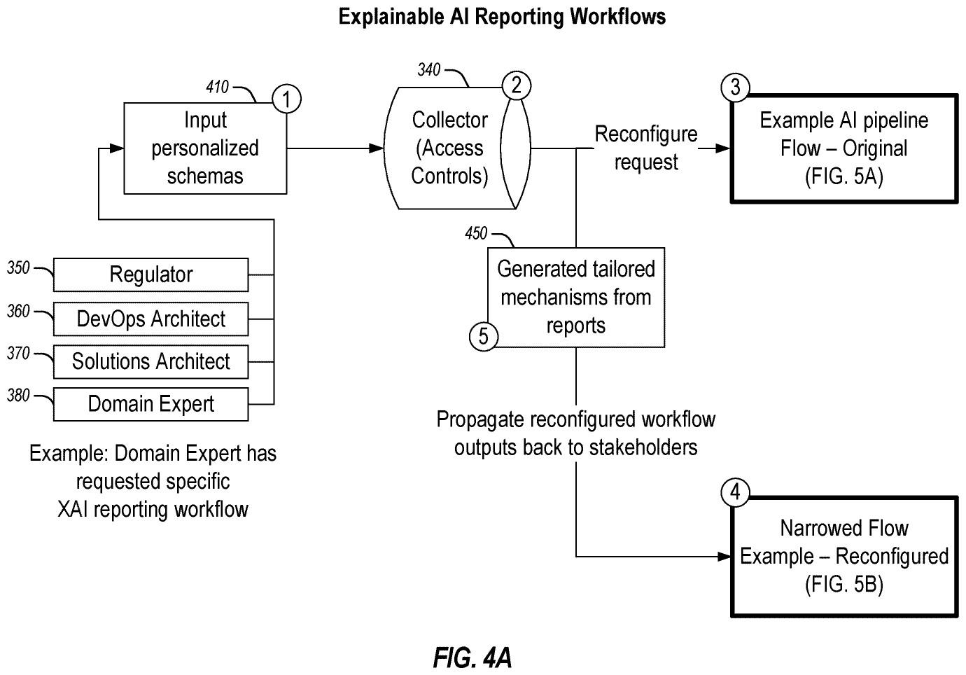

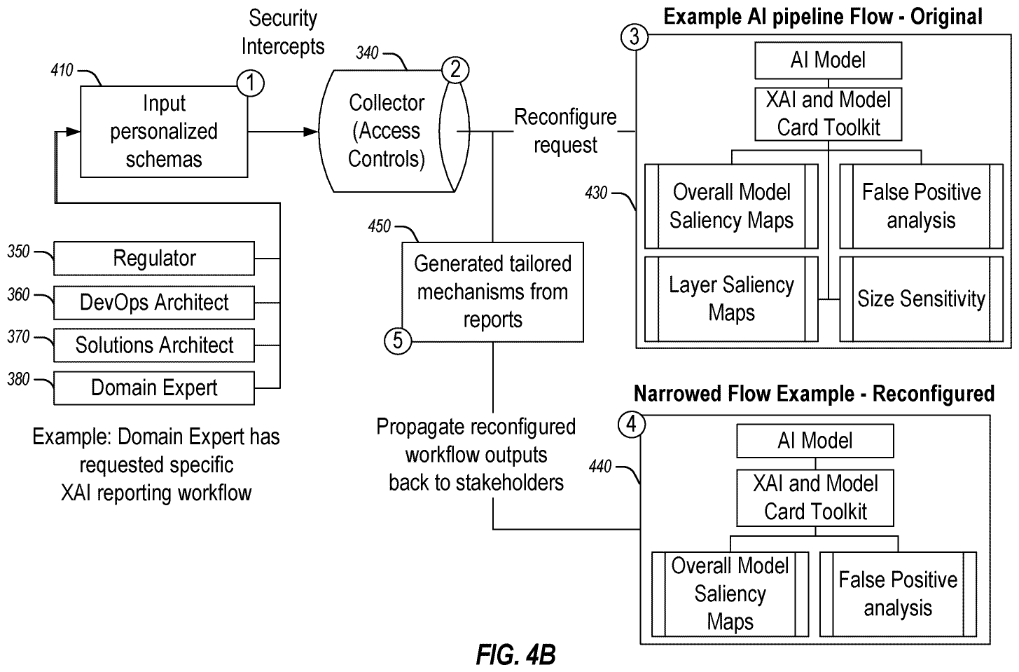

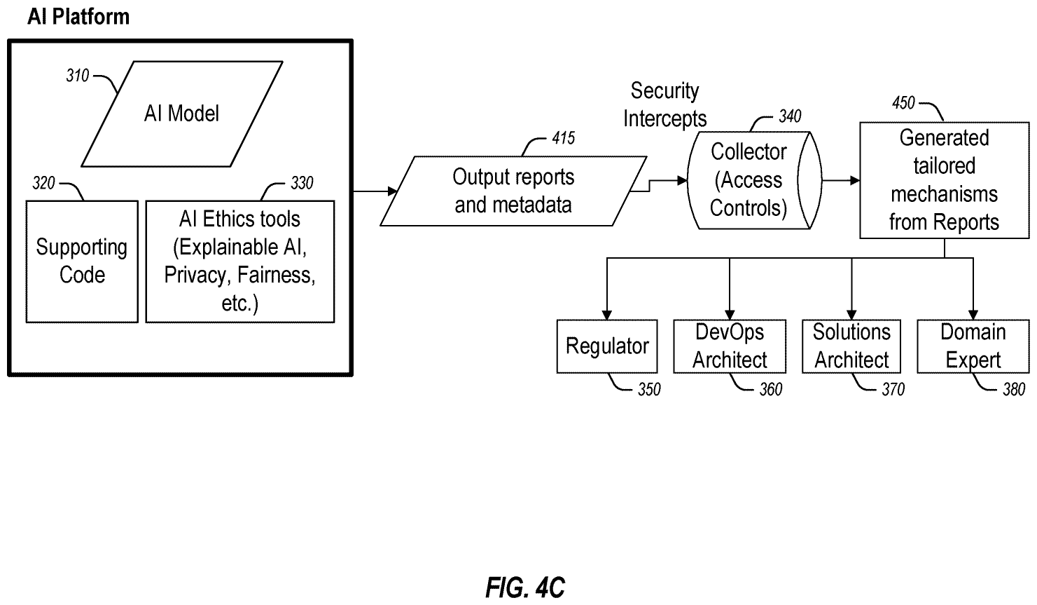

FIG. 4A provides an architecture diagram of an XAI system that includes stakeholder persona customization, such as may be deployed for a deep learning computer vision problem as discussed above. Here, this demonstrates the use of a collector 340 to receive one or more input personalized schemas, in a scenario where a particular persona (e.g., a Domain Expert 380) has requested a specific XAI reporting workflow, with the workflow generally following a sequence of circled tasks (1)-(5). In this scenario, the persona will provide a personalized schema (e.g., with operation 410) as input for analysis by the collector 340. In this example, the controller's objectives are three-fold: (i) Control and orchestrate the XAI and metadata generation processes; (ii) Retrieve the generated telemetry data from the platform and the AI model; and (iii) Generate the tailored mechanisms from the reports (e.g., with operation 450).

The input schema for persona identification may be an industry standard format of specifying inputs to the controller. Examples may include a . yaml/. JSON file, where users may input their preferences in relation to the metadata that will be generated. Another option may be a front-end user interface where users may drag and drop blocks corresponding to metadata generation processes that the collector 340 will then consume and implement. In an example, a definition data file, such as in the sample. yaml/. JSON file, may include metadata to define and enable different workflows depending on the type of persona. Stakeholder expectations are continuously evolving in relation to regulations and industry trends, so the use of a changeable definition data file can help reconcile and modify stakeholder expectations involved in the use case.

FIG. 4B provides a related architecture diagram of an XAI system that includes stakeholder persona customization, which is extended for implementing reconfigurable AI reporting workflows following a similar sequence of circled tasks (1)-(5). Here, operation 430 depicts some of the AI pipeline flow operations from an original workflow (e.g., showing data provided from an AI model, to an XAI and model card toolkit, to produce: overall model saliency maps; false positive analysis; layer saliency maps; or size sensitivity analysis). Operation 440 also depicts a narrowed AI pipeline flow from a reconfigured workflow (e.g., showing data provided from an AI model, to an XAI and model card toolkit, to produce: overall model saliency maps, and false positive analysis).

FIG. 4C provides a related architecture diagram of an XAI system that is extended for post-processing, including segmenting output reports and metadata 415 of telemetry data for relevant users. This can be used to use schemas (e.g., automated schemas) to filter out metadata from ML models and generate tailored mechanisms from reports (e.g., at operation 450) that are customized to one or more stakeholders (e.g., stakeholders 350, 360, 370, 380).

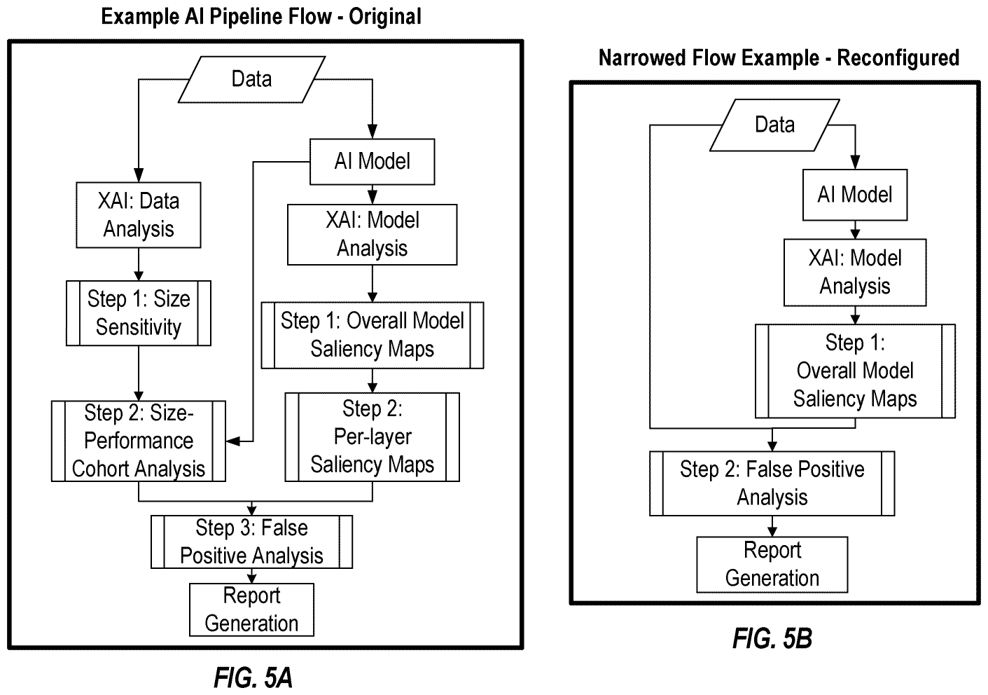

FIGS. 5A and 5B provide further details on an example AI pipeline flow and a narrowed (reconfigured) AI flow, respectively. FIG. 5A depicts how data may be provided to each of an XAI model (e.g., for XAI data analysis) and to an AI model (e.g., for inferencing, regression, processing). FIG. 5B depicts a reconfigured data flow, showing a shorter version where the overall model saliency maps are directly provided to the false positive analysis.

In FIG. 5A, the basic XAI pipeline flow is composed of two smaller sequential workflows corresponding to data analysis and model analysis. This includes a data analysis component, with a workflow. This workflow starts with a dependency on the input data, starts with size sensitivity generation, and leverages the outputs for more detailed cohort analysis sections. In the pipeline flow, the cohort analysis segment also has a dependency on the AI model block for the performance analysis. In parallel, this includes a model analysis segment portion of the XAI workflow addressing a first generation of saliency maps for the overall deep learning model, while a more granular level of saliency maps may be generated per layer. Metadata from both elements is then propagated to a final False Positive analysis block to analyze a specific set of failures of the AI system. A report is then generated from this info and propagated to stakeholders.

In FIG. 5B, the reconfigured AI workflow/pipeline enables users to customize the operations of the XAI process that they would like a report generated for, based on the input schema provided to the controller. Also, users may choose to customize metric definitions. Thus, in the example of FIG. 5B, consider a scenario where there is a domain expert stakeholder who has requested a high-level report only containing overall model saliency maps and the false positives of the AI system, rather than the original pipeline composed of data quality metadata and more detailed saliency map reports. In this scenario, the user may also define flexible policy definitions for input data points.

Scalability concerns for XAI can depend on the AI use case. The approaches discussed herein take this into account through flexibility with the interactions to the collector. In an example, two primary modes of operation are provided for the collector. A first model of operation is applicable to real-time generation of information (e.g., in edge environments). Here, operations of the XAI/reporting pipeline process that are not applicable can be muted. This can reduce runtime and ensure that stakeholders are only exposed to the information they intend to see or have asked for. This may be implemented by a “dynamic” reconfiguration of the pipelines to only generate the data that has been requested. A second model of operation is applicable to stored information. Here, the collector may contact an offline database and selectively serve information to the users without requiring the re-generation of the AI pipeline. If requested metadata elements are not already stored, this option is also convenient in use cases where the AI model's predictions and ground truth annotations are already available, because the requested metadata can be re-generated without having to re-trigger running the AI pipeline. For this option, it is assumed that the collector 340 is interacting with a database stored locally on a system or on the cloud (but a variety of implementations may apply).

The collector 340 can be designed to operate in either cloud or edge environments. The collector 340 may be placed in a trusted zone to exclusively output information corresponding to the input schema passed in by the stakeholders. In an example, the collector 340 is responsible for interacting with processes that gather telemetry data points from the platform that are relevant to analyze performance bottlenecks and failure modes with the AI models.

Consider the following example subset of HW and SW metadata elements that the controller may gather, depending on the information the stakeholders may request:
HW metadata elements:
RAM size of target environment;
Number of CPU Cores in target environment;
Installed SW capabilities (e.g., frameworks);
Workload/Algorithm cost in machine cycles;
Current running workload of target environment (e.g., CPU usage);
System Cache;
Workload Queue size.
SW metadata elements:
Timestamp of the models'run;
Outputs of the model, including predictions;
XAI metadata outputted from the model.

Metadata and XAI processes accompanying the original AI workflow may include these and similar metrics. As discussed above, the implementations of these metrics may be adjusted depending on the problem statement, type of ML model, lifecycle phase, and data format and type, among other factors. However, the XAI workflows described herein enable systematic and comprehensive error analysis at the evaluation or pre-deployment stage of a model lifecycle. The results may be segmented into two primary categories: (i) Systematic error detection in the current model and (ii) Model performance improvement.

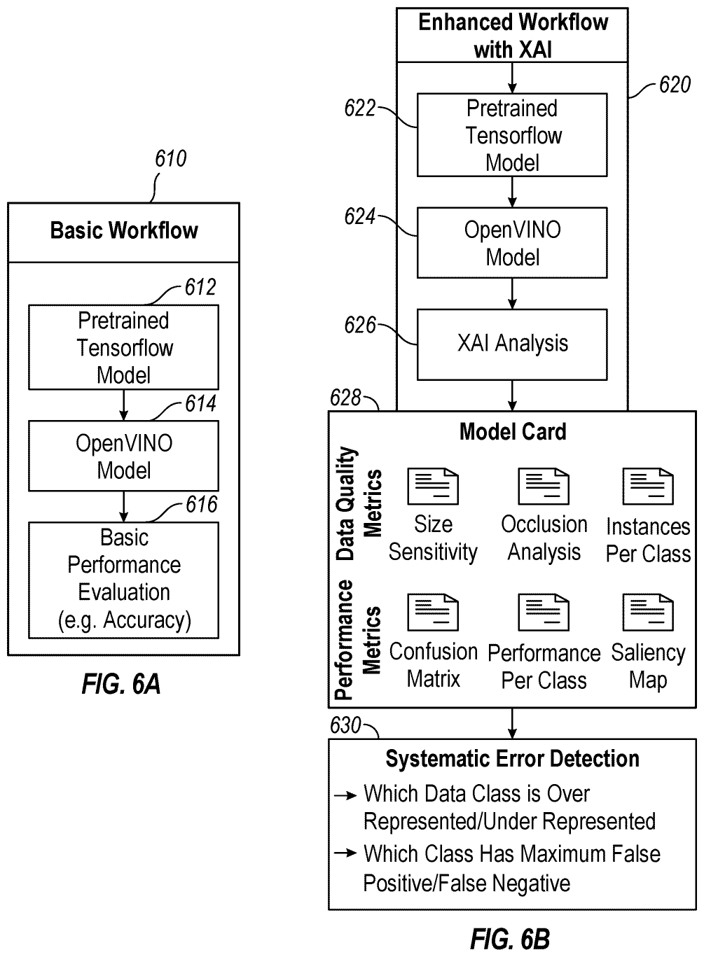

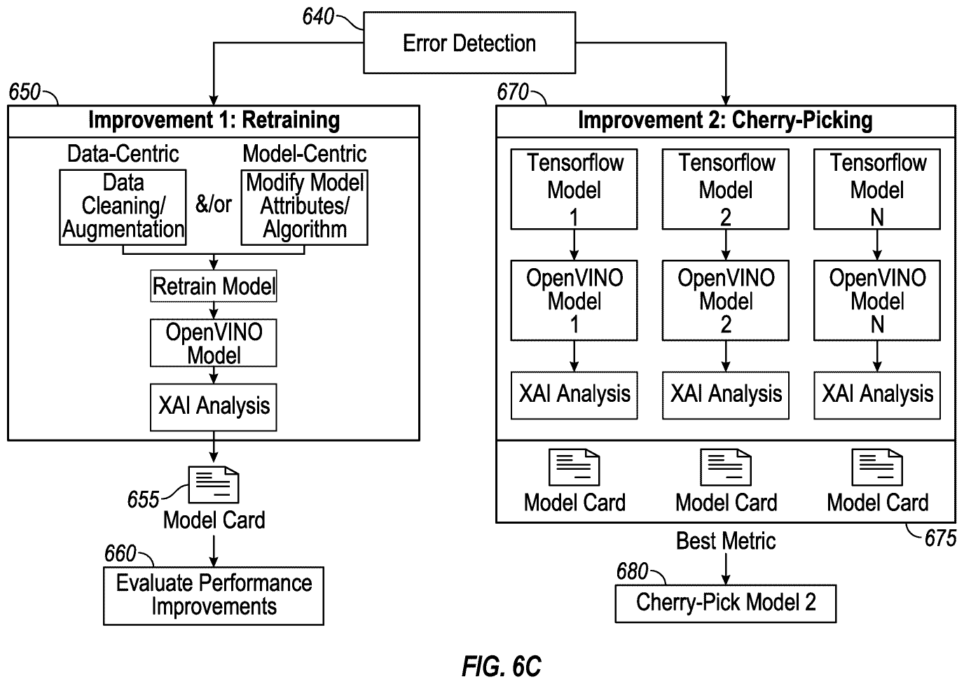

FIGS. 6A to 6C depict workflows for explainable AI use cases. Here, these workflows involve case studies with TensorFlow models as the source model, and Open VINO models as the converted/optimized model (as illustrative examples, but other models may be used). For instance, FIG. 6A provides a flowchart demonstrating a basic workflow 610 of a pretrained TensorFlow model 612 that provides output to an Open VINO model 614, which is then used to provide data to a basic performance evaluation 616 (e.g., an evaluation of model accuracy).

FIG. 6B provides a flowchart demonstrating an enhanced workflow 620 of the pretrained TensorFlow model 622 that also provides output to an Open VINO model 624, and also provides data to an XAI analysis 626. The XAI analysis 626 can be used to generate outputs such as a model card 628 (e.g., that includes data quality metrics such as size sensitivity, occlusion analysis, and instances per class; and that includes performance metrics such as a confusion matrix, performance per class, and saliency map). The results of the model card 628 and other data from the XAI analysis 626 can be used for systematic error detection 630 and similar operations. For example, systematic error detection 630 may be used to determine which data class is over-represented or under-represented; and which class has a maximum false positive or false negative rate. This type of error detection may enable stakeholders to perform a comparative analysis between different model types to identify performance and failures of the systems. Example comparisons can include: Models before/after conversion; Models before/after optimization (e.g., quantization); and Models with varying precision.

In further examples, the results of the XAI evaluation may enable model performance improvement. FIG. 6C provides a flowchart demonstrating model performance improvement, based on the results of error detection 640 in the XAI evaluation, based on a retraining workflow 650 or a manual or autonomous model selection workflow 670 (also referred to as “cherry-picking”). In each of these workflows 650, 670, the additional XAI evaluation operations are used to produce a model card. In the case of the retraining workflow 650, a single model card 655 is produced that can be provided to a performance improvement evaluation 660. In the case of the model selection workflow 670, multiple model cards 675 can be produced to compare metrics, and then cause a model selection 680.

As an explanation of the retraining workflow 650, by leveraging the outputs of the XAI evaluation, the user may choose to re-train the AI system in either a data-centric or model-centric fashion to achieve better performance or minimization of failures for models, applicable during the training AI lifecycle phase. As shown in workflow 650, one form of retraining is data-centric, where the user applies data cleaning or augmentation errors to address issues with the data, such as underrepresentation. As also shown in workflow 650, another form of re-training is model-centric, where the user modifies attributes of the AI model or algorithmic to address issues with failures, such as modification of hyperparameters to reduce the number of false positives.

As an explanation of the manual or autonomous model selection workflow 670, model selection 680 may be applicable during training and inference lifecycle phases. For example, a user may choose to generate multiple model cards 675 and compare statistics between these models to identify which model is performing best on a specific category (and thus, perform a model selection of another model at 680). For example, an AI engineer may wish to understand which deep learning models has the least number of false negatives on an object with larger sizes (size sensitivity), by using the generated performance reports to make a decision on which model to proceed with. Further, model selection may be completed manually by designated stakeholders by comparing generated performance profiles, or the model selection may be completed autonomously by a separate logic that computes and outputs the name of the model with the best performance in a pre-set category.

Based on the examples discussed above, the presently disclosed XAI evaluation techniques may produce the following data explanation and quality metrics, among other types of results.

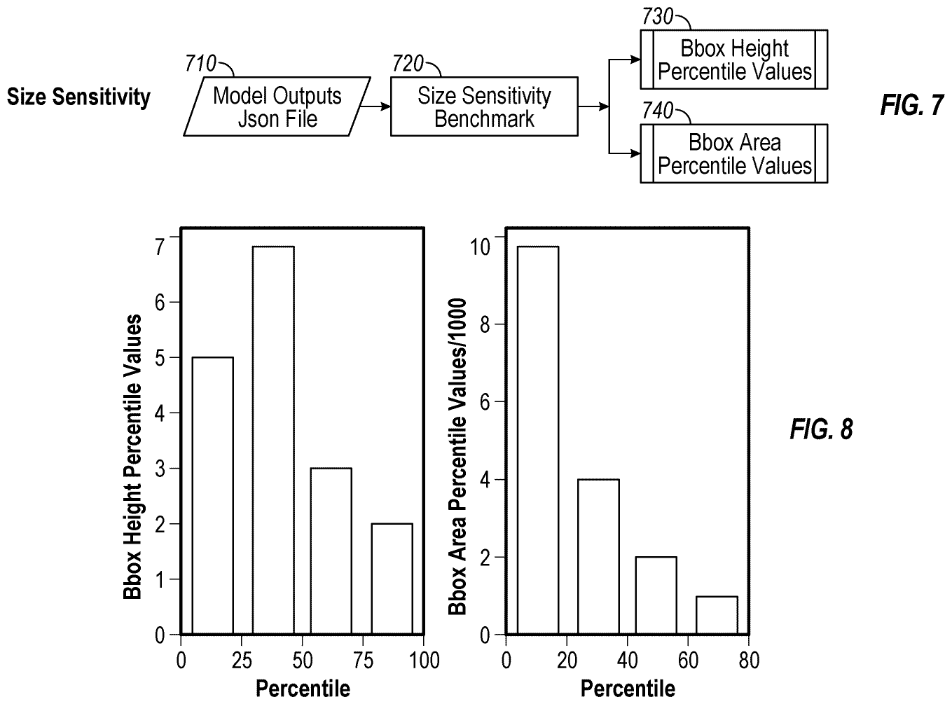

Size Sensitivity: Size sensitivity is a data quality metric that captures the distribution of sizes in the dataset (e.g., using the bounding boxes produced by a Deep Learning detection model). The purpose of this metric is to visualize how represented objects of a particular size are, within the input dataset, which could in turn influence the model's performance downstream. A high-level architecture diagram for use of a size sensitivity mechanism is provided in FIG. 7, and sample graphical representation outputs from a size sensitivity mechanism are provided in FIG. 8. For instance, FIG. 7 shows how model outputs 710 (e.g., produced in a JSON file) are provided for analysis with a size sensitivity benchmark at operation 720. The size sensitivity benchmark produces values such as a bounding box height percentile value 730, and a bounding box area percentile value 740.

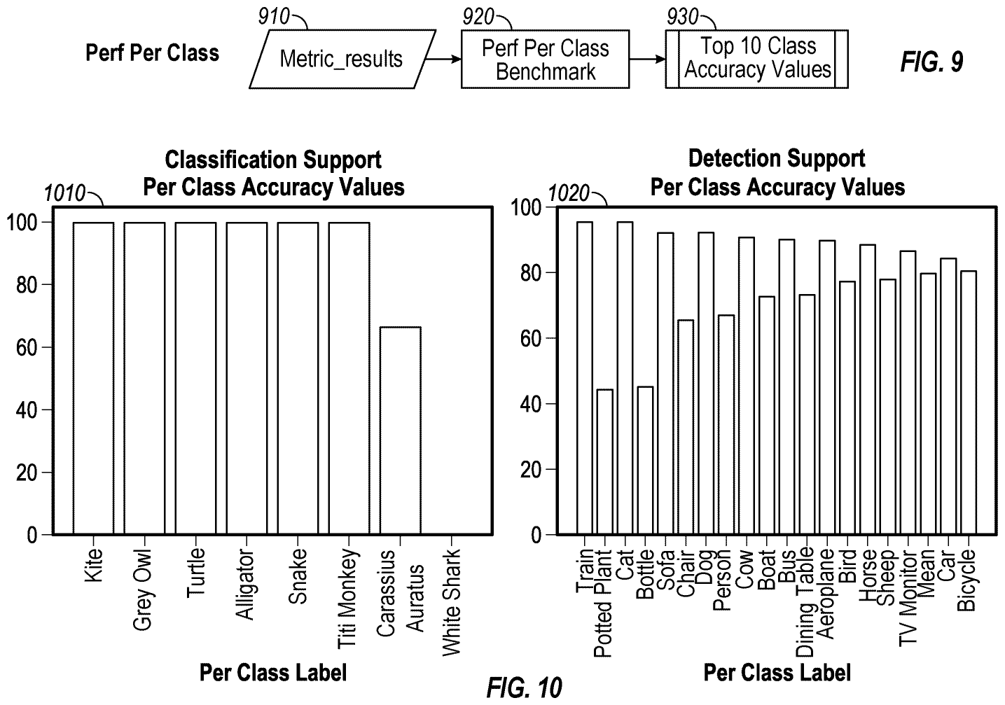

Cohort Analysis: Cohort analysis, also known as performance per class, data slicing, or stratification, can be important to analyze the performance and explainability of methods on data points grouped by labels (for example, at a high-level, “90% accuracy on the dog label, 10% on cat”). Cohort analysis also comes under the AI model quality and explanation metrics, where slices of data are created and the AI model is evaluated on each of these slices. FIG. 9 depicts a high-level architecture diagram for use of a cohort analysis mechanism. Here, metric_results data 910 represents metrics generated using the output predictions of the AI model. This metric_results data 910 can be provided to a benchmark 920 (e.g., a performance per class benchmark), and used to produce data value results 930 (e.g., the top ten class accuracy values). FIG. 10 depicts an example of data slices created corresponding to each of the classes in the dataset, and the AI model's performance being evaluated on these individual slices, with example performance per class break-down (by classification support per class accuracy values 1010 and by detection support per class accuracy values 1020). As will be understood, such analysis can be used with slices of data corresponding to demographic variables (e.g., such as types of race and gender, but many other types of variables may be used) and showing AI performance and fairness metrics on these individual slices.

A cohort analysis mechanism can be considered as part of data quality operations, by performing more detailed cohort analyses that leverage data quality metrics. Further, the slices of data may be made contingent on different types of data quality metrics. These metrics can be flexibly applied for both training and inference datasets. In the case of an AI model training phase/dataset, ground truth annotations can be used to effectively compare to the model's predictions. In the case of an AI model inference phase/dataset, the dependency for metrics such as “performance per class” can be satisfied by quality evaluation stakeholders suppling the ground truth annotations (e.g., “after inference”/offline processing). In the case of real-time inference, a golden dataset of the model's past predictions could be substituted as the ground truth annotations supplied to these metrics.

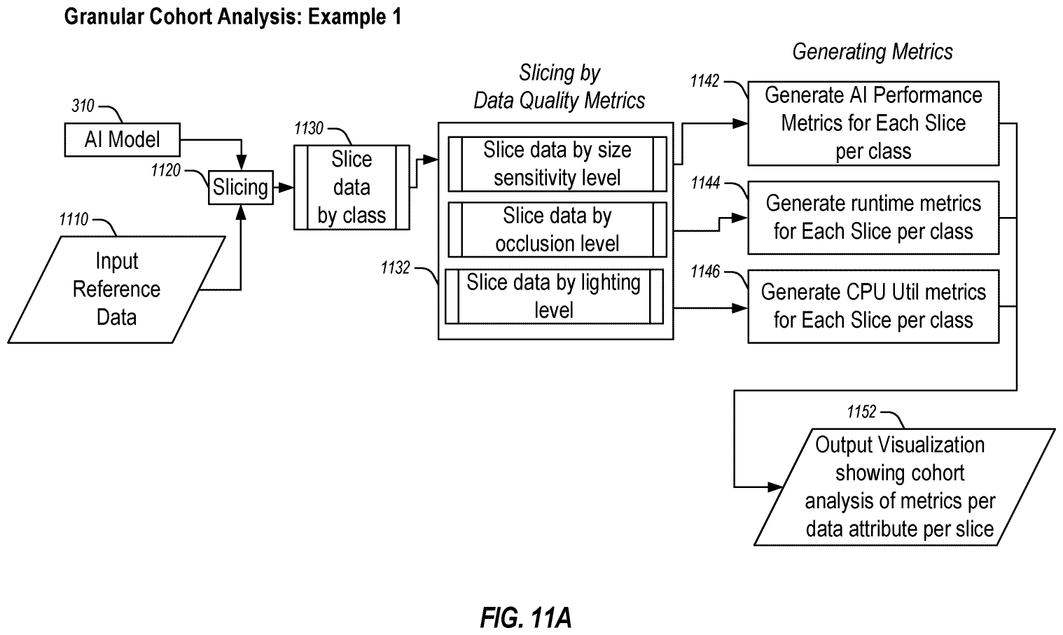

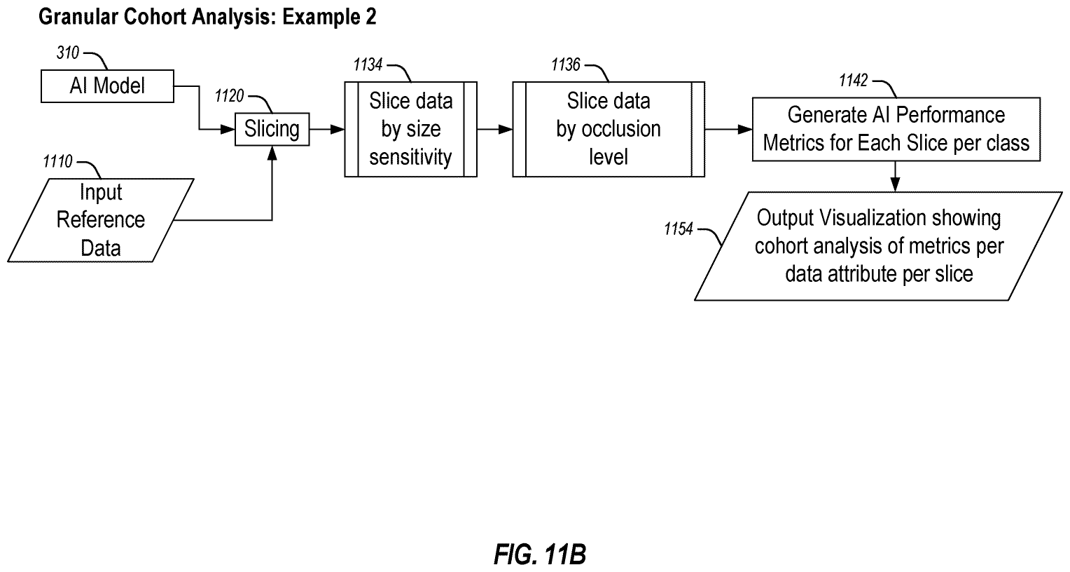

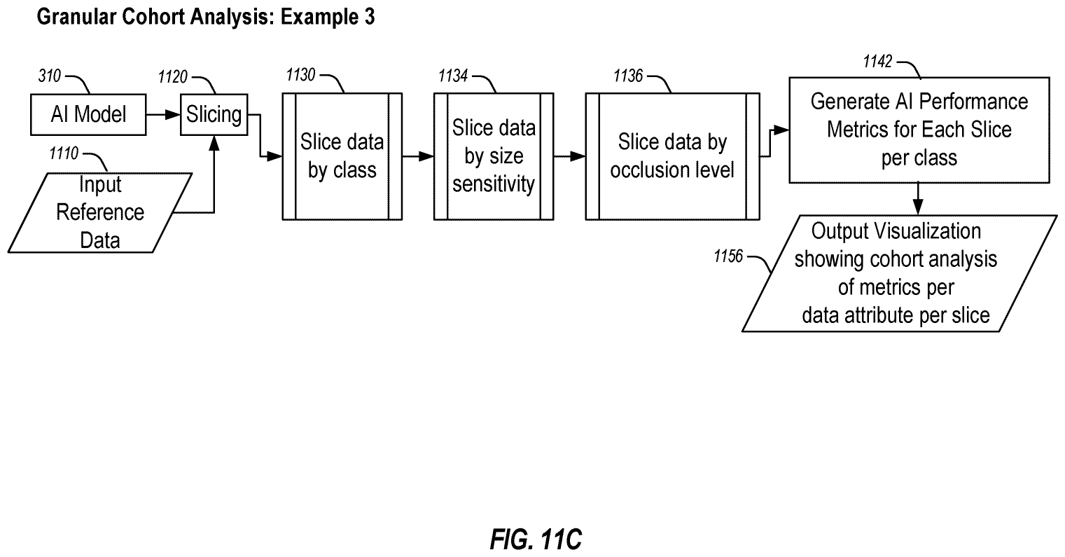

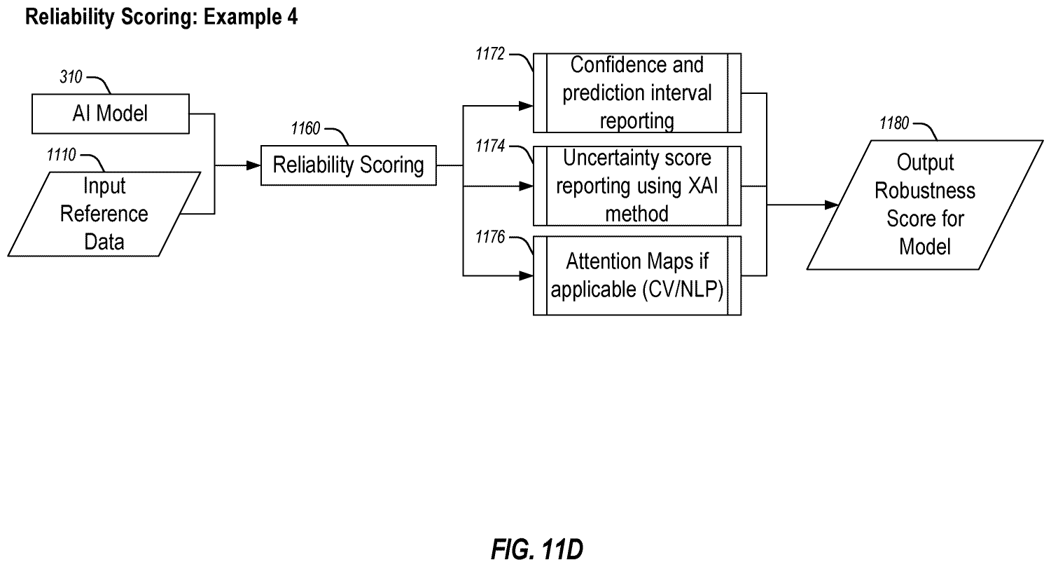

FIG. 11A depicts a first granular cohort analysis, according to another example. First, input data 1110 processed by the AI model 310 can be sliced at 1120 into the individual classes 1130. Then, slicing by data quality metrics 1132 is performed. As an example, a “granular size sensitivity” mechanism can be used to generate splits of the data per class (e.g., for the “person” class, there would be a “large” size split, “small” size split, etc.). Metrics per class reports can then be generated for each of these slices, for example, by generating performance per slice per class, such as 10% accuracy on “small” “tree” objects, 55% accuracy on “large” “tree” objects, 69% accuracy on “medium-sized” “bottle” objects, etc. The metrics can include AI performance at 1142, runtime performance at 1144, CPU utilization at 1146, etc. A representation 1152 (such as that provided in FIG. 13, discussed below) is output to demonstrate a sample pipeline for size sensitivity. Substitutions may include the data quality attributes being substituted for the occlusion level, the lighting, or additional data quality attributes. For use cases that are not computer vision based, these attributes and metrics could be altered accordingly, e.g., looking at different attributes of the text.

FIG. 11B depicts a second granular cohort analysis, according to another example. Multiple data slices can also be generated by interdependencies between the data quality metrics. This is illustrated by the sample pipeline illustrated in the FIG. 11B, which includes data slicing by size sensitivity 1134 and data slicing by occlusion level 1136. AI performance metrics then are generated at 1142 for each slice per class. The AI performance metrics are then provided with an output visualization 1154, showing the cohort analysis of metrics per attribute per slice. A sample output of the pipeline may include, “Large objects have a tendency to have a larger occlusion level in the dataset”.

FIG. 11C depicts a third granular cohort analysis, according to another example. This illustrates how the pipelines from FIGS. 11A and 11B may be combined to form a more complex pipeline for tackling interdependencies between the data quality metrics. FIG. 11C thus depicts interdependency between data elements, with multiple blocks corresponding to data slicing, orchestrated in an iterative fashion from data slicing. Here, based on data slicing for each individual class in a dataset at 1130, data slicing for each individual size sensitivity level per class at 1134, and data slicing for each individual occlusion analysis level (e.g., per size sensitivity cohort) at 1136, AI performance metrics (e.g., accuracy) are generated at 1142. These metrics are used to produce an output visualization 1156 showing cohort analysis of metrics per data attribute per slice. An example output of this pipeline would be: “For medium-sized objects of the bottle class with high levels of occlusion, the AI model reports 30% accuracy”, or “For objects of the people class who appear larger in the frame (e.g., due to distance) with low levels of occlusion, the AI model reports 70% accuracy”.

FIG. 11D depicts a reliability scoring analysis, according to an example. Here, reliability scoring 1160 is performed to produce a robustness score for a model 1180. This framework may also output confidence and prediction interval reporting 1172, an uncertainty score 1174, and attention maps 1176 (e.g., maps for natural language processing (NLP) or heatmaps for computer vision (CV)) if applicable to understand the reliability of the AI system.

In further examples, overall model saliency maps may be generated from the XAI processes discussed herein. Such explanation metrics may use pixel-level attribution methods, such as Grad-CAM or Score-CAM, to generate saliency maps generated for the overall DL model. In one example, saliency maps generated for the overall DL model are based on map(s) generated from the last layer of a neural network. In other examples, per-layer saliency maps are used. Similar to overall model saliency maps, per-layer saliency maps may include generating visualizations for all layers of the neural network that are applicable (e.g., activation layers). Accordingly, per-layer saliency maps may offer more granularity compared to overall model saliency maps and may provide additional information for advanced AI engineers or data scientists.

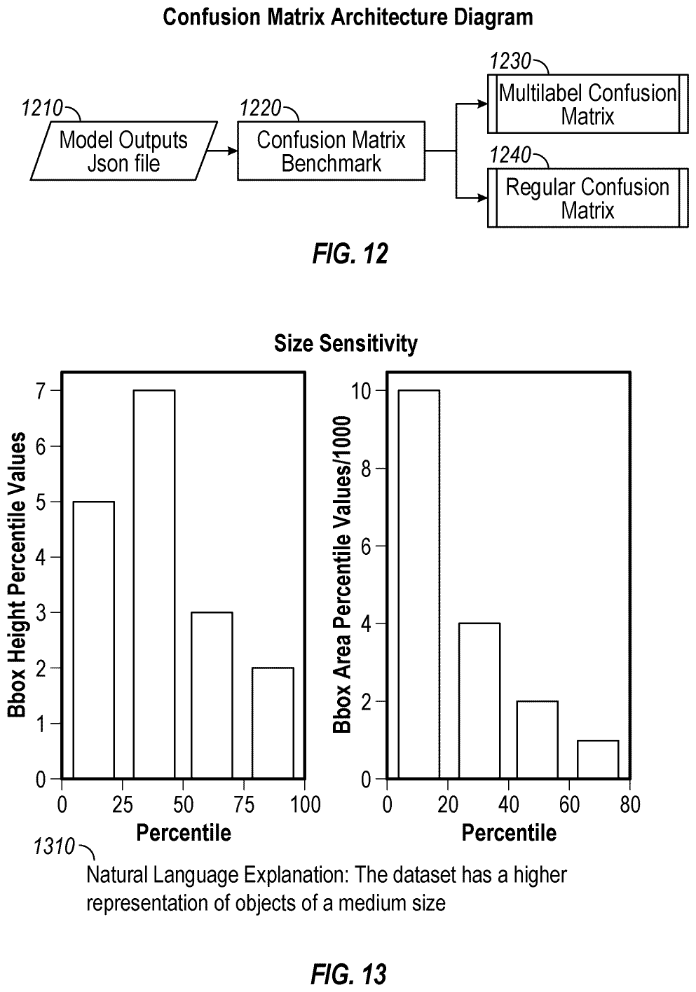

FIG. 12 depicts an architectural diagram for a confusion matrix analysis. In an example, confusion metrics 1230, 1240 are constructed from model outputs data 1210 (e.g., a JSON file) and a confusion matrix benchmark 1220 to identify the false positives and negatives of classification models. Multilabel confusion matrices 1230 may be used show the broader picture of classes that have been mistaken for others. Custom class selection is an important capability here, when it is challenging to find the classes that need to be depicted in this type of diagram for visual comprehensibility (e.g., if there are more than ten classes of interest). Per-class confusion matrices may also offer detailed granularity into the statistics of the false positives, false negatives, true positives, and true negatives of a prediction. False Positive analysis is one subset of confusion matrices. One definition (for classification-based DL methods) involves a model incorrectly making a prediction “true”, when the actual prediction should be of a “false”outcome.

When performing image analysis, e.g., for each of the images generated, it is also possible to implement an autonomously generated natural language explanation (NLE) paired with the image. FIG. 13 depicts a sample example of an NLE interpretation 1310 of the Size Sensitivity results from FIG. 8. The accompanying NLE text is, “The dataset has a higher representation of objects of a medium size.” A variety of language processing and AI-assisted techniques may be used to generate the NLE.

In further examples, various techniques may be extended to filter, segment, and serve XAI reports to a stakeholder. The controller will then provide the information outputted from the XAI workflow to the stakeholder. As noted in the details of the workflows above, a controller can filter the information generated depending on the policies/configuration inputted by the stakeholder, and serve the information to the stakeholder accordingly, e.g., through a web page hosted on a front-end user interface.

Various flexible modes of access may be defined for XAI data. For instance, access control, authorization, and authentication mechanisms must be applied to ensure that the stakeholders with permitted access can access the outputs of the reporting workflow. Multiple stakeholders may have the intention to access and reconfigure the reporting workflow in accordance with their needs. Accordingly, the architectures discussed herein could be applied in scenarios involving different instantiations of the solution for different personas, so the chosen workflow can be modified without impacting the reporting workflow of other stakeholders. The architectures discussed herein could also apply for access control being enabled to stakeholders to perform re-configurations to workflow as needed. This may include granting stakeholders credentials to log into a dashboard of the application, enforcing immutability of certain objects in the workflow, such as those corresponding to core data and AI processing elements, as aligned upon by the participatory stakeholders, and enabling version history, so users may revert to previous versions of the pipeline and potentially access explainability metadata artifacts/lineage.

Moreover, the XAI approaches discussed above enable for systematic and comprehensive error analysis at the evaluation/pre-deployment stage of an AI model lifecycle. The applicable use cases for these XAI approaches can be segmented into two primary categories: (i) Systematic error detection in the current model and (ii) Model performance improvement. These benefits can be applied at varying phases of the AI lifecycle.

As a first example, consider a use case involving XAI personas in a manufacturing or industrial environment. XAI analysis may be used to perform analysis related to: (i) error reduction in correctly locating real-world objects by systems with camera sensors (e.g., based on camera image data that is analyzed with various AI algorithms); (ii) optimized path planning for autonomous mobile robots (AMRs) (e.g., in a confined factory/warehouse using an AI model); (iii) optimization of data routing path in networks (e.g., using dynamic routing algorithms in an AI model); and (iv) processing of sensor data (e.g., from various manufacturing or system sources, analyzed using an AI model). Domain experts and data scientists may leverage XAI analysis to consume metadata generated by edge devices (including cameras, AMRs, industrial systems), and selectively generate and extract relevant metadata to debug the performance of the AI model. Stakeholders may upstream the XAI analysis results and related data through the edge/cloud, to enable a controllable device (e.g., robot) to perform actions offline and to also generate recommendations to data scientists to improve on the action needed.

As a second example, consider a use case involving XAI personas in a retail automation environment. XAI analysis may be used along with remote monitoring use cases, where cloud services are leveraged to enable analysis and solving problems at scale. Consider a use case where retail data is paired with camera data to analyze whether an employee or customer action is correct for the particular scenario, with various AI models being used for object classification and detection purposes. As part of predictive maintenance workflows, an AI model deployed at the edge device (e.g., camera/sensor) may be integrated into an operational dashboard and user interfaces for oversight, review, and updates. Inferences, metadata, input images, and the like can be provided to a compute location to be reviewed by human-in-the-loop team.

As a third example, consider a use case involving XAI personas in a healthcare automation environment. For workflows involving the use of AI models, data scientists can leverage XAI analysis to evaluate the generalizability of the data and to validate AI models (e.g., detailed error breakdown reports of models). Bench scientists (as domain experts) may structure their XAI workflows differently based on XAI analysis, focusing on human comprehensibility (e.g., saliency maps) and validation of appropriateness for the use case.

For any of these domains, the data scientists and subject matter experts/domain experts may identify performance issues with the model and choose to re-train the model or potentially select another kind of model that better suits the purposes, among other options. Accordingly, in these and other use cases, XAI analysis may involve various aspects of: validation during simulation (e.g., before deployment of an AI model, in an attempt to catch issues early during simulation phase); validation during runtime (e.g., to run the AI model in run time to determine where to improve efficiency); selection of AI models (e.g., to “cherry-pick”, or identify if a pre-trained model satisfies given requirements towards failures and performance); and real-time validation (e.g., le to identify when the object detection is failing and make the controlled system behave differently (example: robots to slow down, adjusting trajectory, etc.).

Finally, it will be understood that the preceding XAI techniques and similar examples may also be applicable for digital twin use cases similar to the scenarios mentioned above.

### Example Methods and Implementation Examples

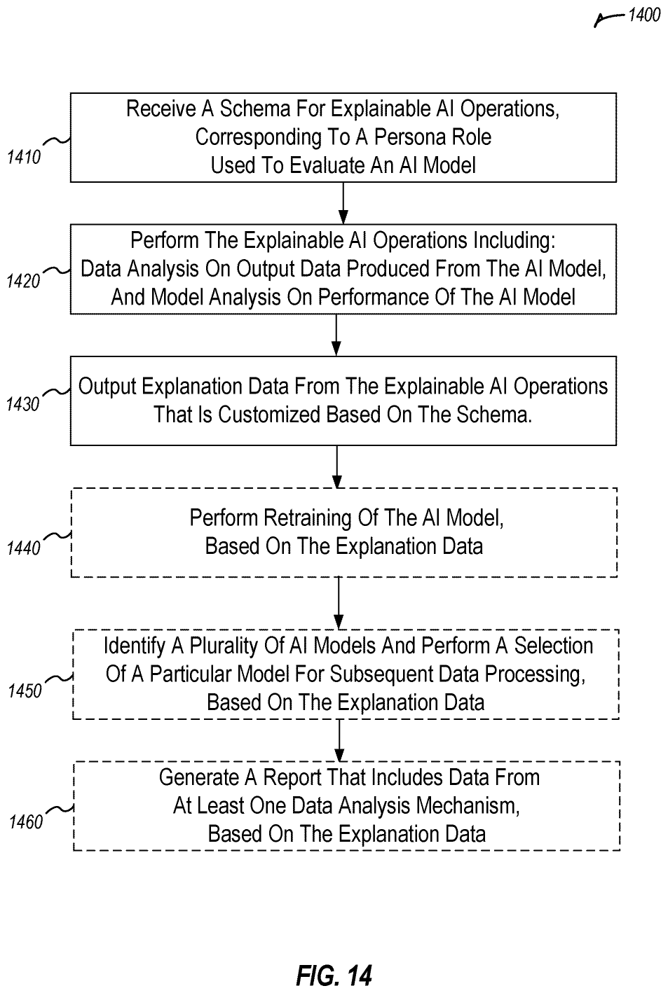

FIG. 14 is a flowchart 1400 of an example method for implementing explainable AI data operations, in connection with XAI analysis performed on one or more AI data model as discussed herein. It will be understood that the details of the following XAI analysis operations may be enhanced by the workflows and pipelines (e.g., discussed above with reference to FIGS. 4A to 6C, and other illustrations). The following operations may be performed, coordinated, orchestrated, or caused by a single computing device (e.g., single node) or multiple computing devices (e.g., multiple nodes operating in a distributed or cloud computing environment), consistent with the characteristics of edge and cloud computing environments.

At 1410, operations include to receive a schema for explainable AI operations. In an example, this schema corresponds to a persona role used to evaluate an AI model, and to obtain particular types of data outputs and perform certain types of AI analysis. Consistent with the examples above, the persona role may be associated with: a regulator, a software development operations architect, a solutions architect, or a domain expert.

At 1420, operations include to cause, orchestrate, initiate, execute, perform, and/or control the explainable AI operations, or a workflow including the explainable AI operations. In an example, the explainable AI operations include: data analysis on output data produced from the AI model, and model analysis on performance of the AI model. In a specific example, the data analysis includes data slicing of the output data based on data quality metrics, and the model analysis includes performance metrics for the AI model based on the data slicing.

Specific examples of explainable AI operations include those which apply to the analysis of an AI model that performs object detection on image data provided as input data to the AI model. For instance, the data quality metrics may correspond to one or more of: data slicing by size sensitivity level, data slicing by occlusion level, or data slicing by lighting level; and the performance metrics may correspond to each slice per object detection class. In this scenario, explanation data that is produced from the explainable AI operations may correspond to metrics per data attribute per slice.

Other examples of explainable AI operations may include reliability scoring based on a processing of input data by the AI model. In this setting, explanation data that is produced from the explainable AI operations may include a robustness score for the AI model, with this robustness score being produced based on the reliability scoring.

At 1430, operations include to output explanation data based on the explainable AI operations. Specifically, the output of this explanation data may be customized to the persona role based on the schema. In a specific example, the explanation data is a visualization, and the visualization provides a representation of the performance metrics that correspond to a cohort analysis. In another specific example, the explanation data includes a natural language explanation of the output data produced from the AI model.

At 1440, optional operations include to perform retraining of the AI model, based on the explanation data. This retraining may occur based on manual or automated actions.

At 1450, optional operations include to identify a plurality of AI models and perform a selection of a particular model for subsequent data processing (selected from the plurality of AI models), based on the explanation data.

At 1460, optional operations include to generate at least one report that includes data from at least one data analysis mechanism, based on the explanation data. In a specific example, the at least one report is customized to the persona role as discussed above.

In another specific example, the explanation data includes a model card for the AI model, and the model card includes multiple data quality metrics and multiple performance metrics. For instance, in a scenario involving computer vision AI model analysis and object detection, the data quality metrics may relate to at least one of size sensitivity, occlusion analysis, or instances per class produced from object detection of the AI model, and the performance metrics may relate to at least one of a confusion matrix, performance per class, or a saliency map produced from the object detection of the AI model. However, these metrics and outputs may be generalized to other types of AI models and use cases, including those that involve generative AI outputs. Further, other metrics may be applicable in other disciplines of computer vision and image processing beyond object detection (such as object classification, action segmentation, etc.).

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

Example 1 is a computing device configured to coordinate explainable artificial intelligence (AI) operations, comprising: processing circuitry; and a memory device including instructions embodied thereon, wherein the instructions, which when executed by the processing circuitry, configure the processing circuitry to cause operations that: receive a schema for the explainable AI operations, the schema corresponding to a persona role used to evaluate an AI model; control the explainable AI operations, the explainable AI operations including: data analysis on output data produced from the AI model, and model analysis on performance of the AI model; and output explanation data based on the explainable AI operations, wherein the explanation data is customized to the persona role based on the schema.

In Example 2, the subject matter of Example 1 optionally includes wherein the data analysis includes data slicing of the output data based on data quality metrics, and wherein the model analysis includes performance metrics for the AI model based on the data slicing.

In Example 3, the subject matter of Example 2 optionally includes wherein the explanation data is a visualization, and wherein the visualization provides a representation of the performance metrics that correspond to a cohort analysis.

In Example 4, the subject matter of any one or more of Examples 2-3 optionally include wherein image data is provided as input data to the AI model, and wherein the AI model performs object detection on the image data; wherein the data quality metrics correspond to one or more of: data slicing by size sensitivity level, data slicing by occlusion level, or data slicing by lighting level; wherein the performance metrics are provided for each slice per object detection class, and wherein the explanation data corresponds to metrics per data attribute per slice.

In Example 5, the subject matter of any one or more of Examples 1-4 optionally include wherein the explainable AI operations include reliability scoring based on a processing of input data by the AI model; wherein the explanation data includes a robustness score for the AI model, and wherein the robustness score is produced based on the reliability scoring.

In Example 6, the subject matter of any one or more of Examples 1-5 optionally include wherein the instructions configure the processing circuitry to cause operations that: perform retraining of the AI model, based on the explanation data.

In Example 7, the subject matter of any one or more of Examples 1-6 optionally include wherein the instructions configure the processing circuitry to cause operations that: identify, based on the explanation data, a plurality of AI models; and select a particular model from the plurality of AI models for subsequent data processing.

In Example 8, the subject matter of any one or more of Examples 1-7 optionally include wherein the explanation data includes a model card for the AI model, wherein the model card includes multiple data quality metrics and multiple performance metrics; wherein the data quality metrics relate to at least one of size sensitivity, occlusion analysis, or instances per class produced from object detection of the AI model; and wherein the performance metrics relate to at least one of a confusion matrix, performance per class, or a saliency map produced from the object detection of the AI model.

In Example 9, the subject matter of any one or more of Examples 1-8 optionally include wherein the explanation data includes a natural language explanation of the output data produced from the AI model.

In Example 10, the subject matter of any one or more of Examples 1-9 optionally include wherein the instructions configure the processing circuitry to cause operations that: generate, based on the explanation data, at least one report that includes data from at least one data analysis mechanism, wherein the at least one report is customized to the persona role; wherein the persona role is associated with: a regulator, a software development operations architect, a solutions architect, or a domain expert.

Example 11 is a method for explainable artificial intelligence (AI) operations, performed by processing circuitry of a computing system, the method comprising: receiving a schema for the explainable AI operations, the schema corresponding to a persona role used to evaluate an AI model; controlling a workflow with the explainable AI operations, the explainable AI operations including: data analysis on output data produced from the AI model, and model analysis on performance of the AI model; and outputting explanation data based on the explainable AI operations, wherein the explanation data is customized to the persona role based on the schema.

In Example 12, the subject matter of Example 11 optionally includes wherein the data analysis includes data slicing of the output data based on data quality metrics, and wherein the model analysis includes performance metrics for the AI model based on the data slicing.

In Example 13, the subject matter of Example 12 optionally includes wherein the explanation data is a visualization, and wherein the visualization provides a representation of the performance metrics that correspond to cohort analysis.

In Example 14, the subject matter of any one or more of Examples 12-13 optionally include wherein image data is provided as input data to the AI model, and wherein the AI model performs object detection on the image data; wherein the data quality metrics correspond to one or more of: data slicing by size sensitivity level, data slicing by occlusion level, or data slicing by lighting level; wherein the performance metrics are provided for each slice per object detection class, and wherein the explanation data corresponds to metrics per data attribute per slice.

In Example 15, the subject matter of any one or more of Examples 11-14 optionally include wherein the explainable AI operations include reliability scoring based on a processing of input data by the AI model; wherein the explanation data includes a robustness score for the AI model, and wherein the robustness score is produced based on the reliability scoring.

In Example 16, the subject matter of any one or more of Examples 11-15 optionally include performing retraining of the AI model, based on the explanation data.

In Example 17, the subject matter of any one or more of Examples 11-16 optionally include identifying, based on the explanation data, a plurality of AI models; and selecting a particular model from the plurality of AI models for subsequent data processing.

In Example 18, the subject matter of any one or more of Examples 11-17 optionally include wherein the explanation data includes a model card for the AI model, wherein the model card includes multiple data quality metrics and multiple performance metrics; wherein the data quality metrics relate to at least one of size sensitivity, occlusion analysis, or instances per class produced from object detection of the AI model; and wherein the performance metrics relate to at least one of a confusion matrix, performance per class, or a saliency map produced from the object detection of the AI model.

In Example 19, the subject matter of any one or more of Examples 11-18 optionally include wherein the explanation data includes a natural language explanation of the output data produced from the AI model.

In Example 20, the subject matter of any one or more of Examples 11-19 optionally include generating, based on the explanation data, at least one report that includes data from at least one data analysis mechanism, wherein the at least one report is customized to the persona role; wherein the persona role is associated with: a regulator, a software development operations architect, a solutions architect, or a domain expert.

Example 21 is at least one machine-readable medium (e.g., a non-transitory storage medium or memory device) capable of storing instructions for explainable artificial intelligence (AI) operations, wherein the instructions when executed by at least one processor cause the at least one processor to perform operations comprising: receiving a schema for the explainable AI operations, the schema corresponding to a persona role used to evaluate an AI model; performing (or, controlling a workflow with) the explainable AI operations, the explainable AI operations including: data analysis on output data produced from the AI model, and model analysis on performance of the AI model; and outputting explanation data based on the explainable AI operations, wherein the explanation data is customized to the persona role based on the schema.

In Example 22, the subject matter of Example 21 optionally includes wherein the data analysis includes data slicing of the output data based on data quality metrics, and wherein the model analysis includes performance metrics for the AI model based on the data slicing.

In Example 23, the subject matter of Example 22 optionally includes wherein the explanation data is a visualization, and wherein the visualization provides a representation of the performance metrics that correspond to cohort analysis.

In Example 24, the subject matter of any one or more of Examples 22-23 optionally include wherein image data is provided as input data to the AI model, and wherein the AI model performs object detection on the image data; wherein the data quality metrics correspond to one or more of: data slicing by size sensitivity level, data slicing by occlusion level, or data slicing by lighting level; wherein the performance metrics are provided for each slice per object detection class, and wherein the explanation data corresponds to metrics per data attribute per slice.

In Example 25, the subject matter of any one or more of Examples 21-24 optionally include wherein the explainable AI operations include reliability scoring based on a processing of input data by the AI model; wherein the explanation data includes a robustness score for the AI model, and wherein the robustness score is produced based on the reliability scoring.

In Example 26, the subject matter of any one or more of Examples 21-25 optionally include performing retraining of the AI model, based on the explanation data.

In Example 27, the subject matter of any one or more of Examples 21-26 optionally include identifying, based on the explanation data, a plurality of AI models; and selecting a particular model from the plurality of AI models for subsequent data processing.

In Example 28, the subject matter of any one or more of Examples 21-27 optionally include wherein the explanation data includes a model card for the AI model, wherein the model card includes multiple data quality metrics and multiple performance metrics; wherein the data quality metrics relate to at least one of size sensitivity, occlusion analysis, or instances per class produced from object detection of the AI model; and wherein the performance metrics relate to at least one of a confusion matrix, performance per class, or a saliency map produced from the object detection of the AI model.

In Example 29, the subject matter of any one or more of Examples 21-28 optionally include wherein the explanation data includes a natural language explanation of the output data produced from the AI model.

In Example 30, the subject matter of any one or more of Examples 21-29 optionally include generating, based on the explanation data, at least one report that includes data from at least one data analysis mechanism, wherein the at least one report is customized to the persona role; wherein the persona role is associated with: a regulator, a software development operations architect, a solutions architect, or a domain expert.

### Example Edge Computing Architectures

Although the previous discussion was provided with reference to specific networked compute deployments, it will be understood that the XAI approaches may be implemented at any number of devices that access services from the “cloud”, devices that access services from the “edge cloud”, or devices that access services from the “data center cloud”.

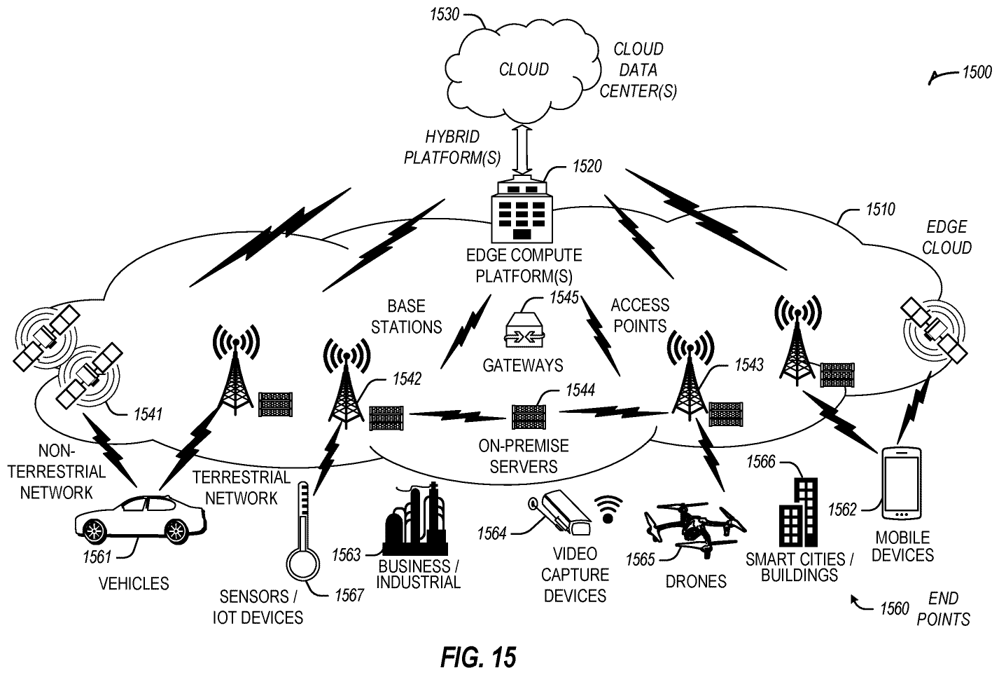

FIG. 15 is a block diagram 1500 showing an overview of a configuration for edge computing, which includes a layer of processing referenced in many of the current examples as an “edge cloud”. This network topology, which may include a number of conventional networking layers (including those not shown herein), may be extended through use of other network communication and compute arrangements.

As shown, the edge cloud 1510 is established from processing operations among one or more edge locations, such as a satellite vehicle 1541, a base station 1542, a network access point 1543, an on premise server 1544, a network gateway 1545, a central office 1520, or similar networked devices and equipment instances. The edge cloud 1510 is located much closer to the endpoint (consumer and producer) data sources 1560 (e.g., autonomous vehicles 1561, user equipment 1562, business and industrial equipment 1563, video capture devices 1564, drones 1565, smart cities and building devices 1566, sensors and IoT devices 1567, etc.) than the cloud data center 1530.

The edge cloud 1510 is generally defined as involving compute that is located closer to endpoints 1560 (e.g., consumer and producer data sources) than the cloud 1530, such as compute deployed closer to autonomous vehicles 1561, user equipment 1562, business and industrial equipment 1563, video capture devices 1564, drones 1565, smart cities and building devices 1566, sensors and IoT devices 1567, etc. Compute, memory, network, and storage resources that are offered at the entities in the edge cloud 1510 can provide ultra-low or improved latency response times for services and functions used by the endpoint data sources as well as reduce network backhaul traffic from the edge cloud 1510 toward cloud 1530 thus improving energy consumption and overall network usages among other benefits.

Compute, memory, and storage are scarce resources, and generally decrease depending on the edge location (e.g., fewer processing resources being available at consumer end point devices than at a base station or at a central office). However, the closer that the edge location is to the endpoint (e.g., UEs), the more that space and power is constrained. Thus, edge computing, as a general design principle, attempts to minimize the amount of resources needed for network services, through the distribution of more resources which are located closer both geographically and in network access time.

In an example, an edge cloud architecture extends beyond typical deployment limitations to address restrictions that some network operators or service providers may have in their own infrastructures. These include, variation of configurations based on the edge location (because edges at a base station level, for instance, may have more constrained performance); configurations based on the type of compute, memory, storage, fabric, acceleration, or like resources available to edge locations, tiers of locations, or groups of locations; the service, security, and management and orchestration capabilities; and related objectives to achieve usability and performance of end services.

Edge computing is a developing paradigm where computing is performed at or closer to the “edge” of a network, typically through the use of a compute platform implemented at base stations, gateways, network routers, or other devices which are much closer to end point devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with compute hardware that performs virtualized network functions and offers compute resources for the execution of services and consumer functions for connected devices. Likewise, within edge computing deployments, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

In contrast to the network architecture of FIG. 15, traditional endpoint (e.g., UE, vehicle-to-vehicle (V2V), vehicle-to-everything (V2X), etc.) applications are reliant on local device or remote cloud data storage and processing to exchange and coordinate information. A cloud data arrangement allows for long-term data collection and storage, but is not optimal for highly time varying data, such as a collision, traffic light change, etc. and may fail in attempting to meet latency challenges. The extension of AI processing capabilities within an edge computing network provides even more possible permutations of managing compute, data, bandwidth, resources, service levels, and the like.

Depending on the real-time requirements in a communications context, a hierarchical structure of data processing and storage nodes may be defined in an edge computing deployment. For example, such a deployment may include local ultra-low-latency processing, regional storage and processing as well as remote cloud datacenter-based storage and processing. Key performance indicators (KPIs) may be used to identify where sensor data is best transferred and where it is processed or stored. This typically depends on the ISO layer dependency of the data. For example, lower layer (PHY, MAC, routing, etc.) data typically changes quickly and is better handled locally in order to meet latency requirements. Higher layer data such as Application Layer data is typically less time critical and may be stored and processed in a remote cloud datacenter.

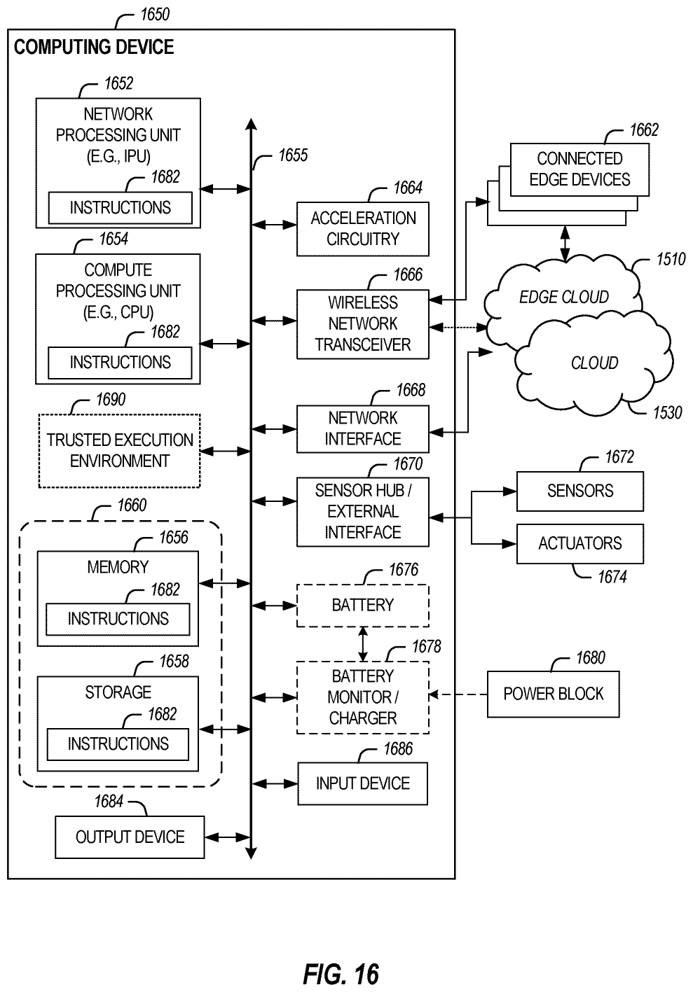

FIG. 16 depicts a block diagram of example components in a computing device 1650 that can operate as a compute processing platform. The computing device 1650 may include any combinations of the components referenced above, implemented as integrated circuits (ICs), as a package or system-on-chip (SoC), or as portions thereof, discrete electronic devices, or other modules, logic, instruction sets, programmable logic or algorithms, hardware, hardware accelerators, software, firmware, or a combination thereof adapted in the computing device 1650, or as components otherwise incorporated within a larger system. Specifically, the computing device 1650 may include processing circuitry comprising one or both of a network processing unit 1652 (e.g., an infrastructure processing unit (IPU) or data processing unit (DPU)) and a compute processing unit 1654 (e.g., a CPU).

The network processing unit 1652 may provide a networked specialized processing unit such as an IPU, DPU, network processor, or other “xPU” outside of the central processing unit (CPU). The processing unit may be embodied as a standalone circuit or circuit package, integrated within an SoC, integrated with networking circuitry (e.g., in a SmartNIC), or integrated with acceleration circuitry, storage devices, or AI or specialized hardware, consistent with the examples above.

The compute processing unit 1654 may provide a processor as a central processing unit (CPU) microprocessor, multi-core processor, multithreaded processor, an ultra-low voltage processor, an embedded processor, or other forms of a special purpose processing unit or specialized processing unit for compute operations.

Either the network processing unit 1652 or the compute processing unit 1654 may be a part of a system on a chip (SoC) which includes components formed into a single integrated circuit or a single package. The network processing unit 1652 or the compute processing unit 1654 and accompanying circuitry may be provided in a single socket form factor, multiple socket form factor, or a variety of other formats.

The processing units 1652, 1654 may communicate with a system memory 1656 (e.g., random access memory (RAM)) over an interconnect 1655 (e.g., a bus). In an example, the system memory 1656 may be embodied as volatile (e.g., dynamic random access memory (DRAM), etc.) memory. Any number of memory devices may be used to provide for a given amount of system memory. A storage 1658 may also couple to the processor 1652 via the interconnect 1655 to provide for persistent storage of information such as data, applications, operating systems, and so forth. In an example, the storage 1658 may be implemented as non-volatile storage such as a solid-state disk drive (SSD). A “memory device” or “storage medium” as used herein may encompass any combination of volatile or non-volatile memory or storage-and thus, may include the system memory 1656, the storage 2058, cache on the processor 1652, among other examples.

The components may communicate over the interconnect 1655. The interconnect 1655 may include any number of technologies, including industry-standard architecture (ISA), extended ISA (EISA), peripheral component interconnect (PCI), peripheral component interconnect extended (PCIx), PCI express (PCIe), Compute Express Link (CXL), or any number of other technologies. The interconnect 1655 may couple the processing units 1652, 1654 to a transceiver 1666, for communications with connected edge devices 1662.

The transceiver 1666 may use any number of frequencies and protocols. For example, a wireless local area network (WLAN) unit may implement Wi-Fi® communications in accordance with the Institute of Electrical and Electronics Engineers (IEEE) 802.11 standard, or a wireless wide area network (WWAN) unit may implement wireless wide area communications according to a cellular, mobile network, or other wireless wide area protocol. The wireless network transceiver 1666 (or multiple transceivers) may communicate using multiple standards or radios for communications at a different range. A wireless network transceiver 1666 (e.g., a radio transceiver) may be included to communicate with devices or services in the edge cloud 1510 or the cloud 1530 via local or wide area network protocols.

The communication circuitry (e.g., transceiver 1666, network interface 1668, external interface 1670, etc.) may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, an IoT protocol such as IEEE 802.15.4 or ZigBee®, Matter®, low-power wide-area network (LPWAN) or low-power wide-area (LPWA) protocols, etc.) to effect such communication. Given the variety of types of applicable communications from the device to another component or network, applicable communications circuitry used by the device may include or be embodied by any one or more of components 1666, 1668, or 1670. Accordingly, in various examples, applicable means for communicating (e.g., receiving, transmitting, etc.) may be embodied by such communications circuitry.

The computing device 1650 may include or be coupled to acceleration circuitry 1664, which may be embodied by one or more AI accelerators, a neural compute stick, neuromorphic hardware, an FPGA, an arrangement of GPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. Accordingly, in various examples, applicable means for acceleration may be embodied by such acceleration circuitry.

The interconnect 1655 may couple the processing units 1652, 1654 to a sensor hub or external interface 1670 that is used to connect additional devices or subsystems. The devices may include sensors 1672, such as accelerometers, level sensors, flow sensors, optical light sensors, camera sensors, temperature sensors, global navigation system (e.g., GPS) sensors, pressure sensors, pressure sensors, and the like. The hub or interface 1670 further may be used to connect the edge computing device 1650 to actuators 1674, such as power switches, valve actuators, an audible sound generator, a visual warning device, and the like.

In some optional examples, various input/output (I/O) devices may be present within or connected to, the edge computing device 1650. For example, a display or other output device 1684 may be included to show information, such as sensor readings or actuator position. An input device 1686, such as a touch screen or keypad may be included to accept input. An output device 1684 may include any number of forms of audio or visual display, including simple visual outputs such as LEDs or more complex outputs such as display screens (e.g., LCD screens), with the output of characters, graphics, multimedia objects, and the like being generated or produced from the operation of the edge computing device 1650.

A battery 1676 may power the edge computing device 1650, although, in examples in which the edge computing device 1650 is mounted in a fixed location, it may have a power supply coupled to an electrical grid, or the battery may be used as a backup or for temporary capabilities. A battery monitor/charger 1678 may be included in the edge computing device 1650 to track the state of charge (SoCh) of the battery 1676. The battery monitor/charger 1678 may be used to monitor other parameters of the battery 1676 to provide failure predictions, such as the state of health (SoH) and the state of function (SoF) of the battery 1676. A power block 1680, or other power supply coupled to a grid, may be coupled with the battery monitor/charger 1678 to charge the battery 1676.

In an example, the instructions 1682 on the processing units 1652, 1654 (separately, or in combination with the instructions 1682 of the machine-readable medium 1660) may configure execution or operation of a trusted execution environment (TEE) 1690. In an example, the TEE 1690 operates as a protected area accessible to the processing units 1652, 1654 for secure execution of instructions and secure access to data. Other aspects of security hardening, hardware roots-of-trust, and trusted or protected operations may be implemented in the edge computing device 1650 through the TEE 1690 and the processing units 1652, 1654.

The edge computing device 1650 may be a server, appliance computing devices, and/or any other type of computing device with the various form factors discussed above. For example, the edge computing device 1650 may be provided by an appliance computing device that is a self-contained electronic device including a housing, a chassis, a case, or a shell.

In an example, the instructions 1682 provided via the memory 1656, the storage 1658, or the processing units 1652, 1654 may be embodied as a non-transitory, machine-readable medium 1660 including code to direct the processor 1652 to perform electronic operations in the edge computing device 1650. The processing units 1652, 1654 may access the non-transitory, machine-readable medium 1660 over the interconnect 1655. For instance, the non-transitory, machine-readable medium 1660 may be embodied by devices described for the storage 1658 or may include specific storage units such as optical disks, flash drives, or any number of other hardware devices. The non-transitory, machine-readable medium 1660 may include instructions to direct the processing units 1652, 1654 to perform a specific sequence or flow of actions, for example, as described with respect to the flowchart(s) and block diagram(s) of operations and functionality discussed herein. As used herein, the terms “memory device”, “storage device”, “machine-readable medium”, “machine-readable storage”, “computer-readable storage”, and “computer-readable medium” are interchangeable.

In further examples, a machine-readable medium also includes any tangible medium that is capable of storing, encoding, or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. The instructions embodied by a machine-readable medium may further be transmitted or received over a communications network using a transmission medium via a network interface device utilizing any one of a number of transfer protocols (e.g., HTTP).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers.

In further examples, a software distribution platform (e.g., one or more servers and one or more storage devices) may be used to distribute software, such as the example instructions discussed above, to one or more devices, such as example processor platform(s) and/or example connected edge devices noted above. The example software distribution platform may be implemented by any computer server, data facility, cloud service, etc., capable of storing and transmitting software to other computing devices. In some examples, the providing entity is a developer, a seller, and/or a licensor of software, and the receiving entity may be consumers, users, retailers, OEMs, etc., that purchase and/or license the software for use and/or re-sale and/or sub-licensing.

In some examples, the instructions are stored on storage devices of the software distribution platform in a particular format. A format of computer readable instructions includes, but is not limited to a particular code language (e.g., Java, JavaScript, Python, C, C #, SQL, HTML, etc.), and/or a particular code state (e.g., uncompiled code (e.g., ASCII), interpreted code, linked code, executable code (e.g., a binary), etc.). In some examples, the computer readable instructions stored in the software distribution platform are in a first format when transmitted to an example processor platform(s). In some examples, the first format is an executable binary in which particular types of the processor platform(s) can execute. However, in some examples, the first format is uncompiled code that requires one or more preparation tasks to transform the first format to a second format to enable execution on the example processor platform(s). For instance, the receiving processor platform(s) may need to compile the computer readable instructions in the first format to generate executable code in a second format that is capable of being executed on the processor platform(s). In still other examples, the first format is interpreted code that, upon reaching the processor platform(s), is interpreted by an interpreter to facilitate execution of instructions.

Although these implementations have been described with reference to specific exemplary aspects, it will be evident that various modifications and changes may be made to these aspects without departing from the broader scope of the present disclosure. Many of the arrangements and processes described herein can be used in combination or in parallel implementations that involve terrestrial network connectivity (where available) to increase network bandwidth/throughput and to support additional edge services. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. This Detailed Description, therefore, is not to be taken in a limiting sense, and the scope of various aspects is defined only by the appended claims, along with the full range of equivalents to which such claims are entitled.

Such aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

1.-21. (canceled)

22. A computing device configured to coordinate explainable artificial intelligence (AI) operations, comprising:
processing circuitry; and
a memory device including instructions embodied thereon, wherein the instructions, which when executed by the processing circuitry, configure the processing circuitry to cause operations that:
receive a schema for the explainable AI operations, the schema corresponding to a persona role used to evaluate an AI model;
control the explainable AI operations, the explainable AI operations including:
data analysis on output data produced from the AI model, and model analysis on performance of the AI model; and
output explanation data based on the explainable AI operations, wherein the explanation data is customized to the persona role based on the schema.

23. The computing device of claim 22, wherein the data analysis includes data slicing of the output data based on data quality metrics, and wherein the model analysis includes performance metrics for the AI model based on the data slicing.

24. The computing device of claim 23, wherein the explanation data is a visualization, and wherein the visualization provides a representation of the performance metrics that correspond to a cohort analysis.

25. The computing device of claim 23, wherein image data is provided as input data to the AI model, and wherein the AI model performs object detection on the image data;
wherein the data quality metrics correspond to one or more of: data slicing by size sensitivity level, data slicing by occlusion level, or data slicing by lighting level;
wherein the performance metrics are provided for each slice per object detection class, and wherein the explanation data corresponds to metrics per data attribute per slice.

26. The computing device of claim 22, wherein the explainable AI operations include reliability scoring based on a processing of input data by the AI model;
wherein the explanation data includes a robustness score for the AI model, and wherein the robustness score is produced based on the reliability scoring.

27. The computing device of claim 22, wherein the instructions configure the processing circuitry to cause operations that:
perform retraining of the AI model, based on the explanation data.

28. The computing device of claim 22, wherein the instructions configure the processing circuitry to cause operations that:
identify, based on the explanation data, a plurality of AI models; and
select a particular model from the plurality of AI models for subsequent data processing.

29. The computing device of claim 22, wherein the explanation data includes a model card for the AI model, wherein the model card includes multiple data quality metrics and multiple performance metrics;
wherein the data quality metrics relate to at least one of size sensitivity, occlusion analysis, or instances per class produced from object detection of the AI model; and
wherein the performance metrics relate to at least one of a confusion matrix, performance per class, or a saliency map produced from the object detection of the AI model.

30. The computing device of claim 22, wherein the explanation data includes a natural language explanation of the output data produced from the AI model, and wherein the instructions configure the processing circuitry to cause operations that:
generate, based on the explanation data, at least one report that includes data from at least one data analysis mechanism, wherein the at least one report is customized to the persona role;
wherein the persona role is associated with: a regulator, a software development operations architect, a solutions architect, or a domain expert.

31. A method for explainable artificial intelligence (AI) operations, performed by processing circuitry of a computing system, the method comprising:
receiving a schema for the explainable AI operations, the schema corresponding to a persona role used to evaluate an AI model;
controlling a workflow with the explainable AI operations, the explainable AI operations including: data analysis on output data produced from the AI model, and model analysis on performance of the AI model; and
outputting explanation data based on the explainable AI operations, wherein the explanation data is customized to the persona role based on the schema.

32. The method of claim 31, wherein the data analysis includes data slicing of the output data based on data quality metrics, and wherein the model analysis includes performance metrics for the AI model based on the data slicing.

33. The method of claim 32, wherein the explanation data is a visualization, and wherein the visualization provides a representation of the performance metrics that correspond to cohort analysis.

34. The method of claim 32, wherein image data is provided as input data to the AI model, and wherein the AI model performs object detection on the image data;
wherein the data quality metrics correspond to one or more of: data slicing by size sensitivity level, data slicing by occlusion level, or data slicing by lighting level;
wherein the performance metrics are provided for each slice per object detection class, and wherein the explanation data corresponds to metrics per data attribute per slice.

35. The method of claim 31, wherein the explainable AI operations include reliability scoring based on a processing of input data by the AI model;
wherein the explanation data includes a robustness score for the AI model, and wherein the robustness score is produced based on the reliability scoring.

36. The method of claim 31, further comprising:
performing retraining of the AI model, based on the explanation data.

37. The method of claim 31, further comprising:
identifying, based on the explanation data, a plurality of AI models; and
selecting a particular model from the plurality of AI models for subsequent data processing.

38. The method of claim 31, wherein the explanation data includes a model card for the AI model, wherein the model card includes multiple data quality metrics and multiple performance metrics;
wherein the data quality metrics relate to at least one of size sensitivity, occlusion analysis, or instances per class produced from object detection of the AI model; and
wherein the performance metrics relate to at least one of a confusion matrix, performance per class, or a saliency map produced from the object detection of the AI model.

39. The method of claim 31, wherein the explanation data includes a natural language explanation of the output data produced from the AI model.

40. The method of claim 31, further comprising:
generating, based on the explanation data, at least one report that includes data from at least one data analysis mechanism, wherein the at least one report is customized to the persona role;
wherein the persona role is associated with: a regulator, a software development operations architect, a solutions architect, or a domain expert.

41. At least one non-transitory machine-readable medium capable of storing instructions for explainable artificial intelligence (AI) operations, wherein the instructions when executed by at least one processor cause the at least one processor to:
receive a schema for the explainable AI operations, the schema corresponding to a persona role used to evaluate an AI model;
control the explainable AI operations, the explainable AI operations including: data analysis on output data produced from the AI model, and model analysis on performance of the AI model; and
output explanation data based on the explainable AI operations, wherein the explanation data is customized to the persona role based on the schema.
